(19) United States
(12) Patent Application Publication
(10) Pub. No.: US 2024/0064751 A1
(43) Pub. Date: Feb. 22, 2024

(54) CROSS SUB-BAND SCHEDULING IN A FULL-DUPLEX NETWORK

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Abdelrahman Mohamed Ahmed Mohamed IBRAHIM, San Diego, CA (US)

(21) Appl. No.: 17/820,136

(22) Filed: Aug. 16, 2022

(51) Int. Cl. H04W 72/14; H04W 72/12

(52) U.S. Cl. CPC H04W 72/14; H04W 72/1205

(57) ABSTRACT

Various aspects of the present disclosure generally relate to wireless communication. In some aspects, a user equipment (UE) may receive a bandwidth part (BWP) configuration indicating that a BWP is configured with cross sub-band scheduling, the BWP configuration indicating at least one sub-band associated with the BWP in which grants are to be received. The UE may receive, in the at least one sub-band, downlink control information (DCI) including a grant that schedules a communication in one or more sub-bands associated with the BWP. Numerous other aspects are provided.

### FIELD OF THE DISCLOSURE

Aspects of the present disclosure generally relate to wireless communication and specifically, to techniques and apparatuses for cross sub-band scheduling in a full-duplex network.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LIE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

In the case of full-duplex communication, it is possible that a bandwidth part (BWP) may span more than one sub-band (in some combination of one or more downlink sub-bands and one or more uplink sub-bands). For example, to reduce or eliminate delay, it is undesirable to switch or modify a configuration of a BWP during the course of full-duplex communication when transitioning from a half-duplex slot to a full-duplex slot. Therefore, the BWP may in some scenarios span more than one sub-band. However, power consumption of the UE could be unnecessarily high in some full-duplex scenarios in which the BWP spans more than one sub-band and a network node schedules a UE in only one sub-band of the BWP (because the UE would still process the entire bandwidth of the BWP).

### SUMMARY

Some aspects described herein relate to a method of wireless communication performed by a user equipment (UE). The method may include receiving a bandwidth part (BWP) configuration indicating that a BWP is configured with cross sub-band scheduling, the BWP configuration indicating at least one sub-band associated with the BWP in which grants are to be received. The method may include receiving, in the at least one sub-band, downlink control information (DCI) including a grant that schedules a communication in one or more sub-bands associated with the BWP.

Some aspects described herein relate to a method of wireless communication performed by a network node. The method may include transmitting a BWP configuration indicating that a BWP is configured with cross sub-band scheduling, the BWP configuration indicating at least one sub-band associated with the BWP in which grants are to be transmitted. The method may include transmitting, in the at least one sub-band, DCI including a grant that schedules a communication in one or more sub-bands associated with the BWP.

Some aspects described herein relate to a UE for wireless communication. The UE may include at least one processor and at least one memory, communicatively coupled with the at least one processor, that stores processor-readable code. The processor-readable code, when executed by the at least one processor, may be configured to cause the UE to receive a BWP configuration indicating that a BWP is configured with cross sub-band scheduling, the BWP configuration indicating at least one sub-band associated with the BWP in which grants are to be received. The processor-readable code, when executed by the at least one processor, may be configured to cause the UE to receive, in the at least one sub-band, DCI including a grant that schedules a communication in one or more sub-bands associated with the BWP.

Some aspects described herein relate to a network node for wireless communication. The network node may include at least one processor and at least one memory, communicatively coupled with the at least one processor, that stores processor-readable code. The processor-readable code, when executed by the at least one processor, may be configured to cause the network node to transmit a BWP configuration indicating that a BWP is configured with cross sub-band scheduling, the BWP configuration indicating at least one sub-band associated with the BWP in which grants are to be transmitted. The processor-readable code, when executed by the at least one processor, may be configured to cause the network node to transmit, in the at least one sub-band, DCI including a grant that schedules a communication in one or more sub-bands associated with the BWP.

Some aspects described herein relate to a non-transitory computer-readable medium that stores a set of instructions for wireless communication by a UE. The set of instructions, when executed by one or more processors of the UE, may cause the UE to receive a BWP configuration indicating that a BWP is configured with cross sub-band scheduling, the BWP configuration indicating at least one sub-band associated with the BWP in which grants are to be received. The set of instructions, when executed by one or more processors of the UE, may cause the UE to receive, in the at least one sub-band, DCI including a grant that schedules a communication in one or more sub-bands associated with the BWP.

Some aspects described herein relate to a non-transitory computer-readable medium that stores a set of instructions for wireless communication by a network node. The set of instructions, when executed by one or more processors of the network node, may cause the network node to transmit a BWP configuration indicating that a BWP is configured with cross sub-band scheduling, the BWP configuration indicating at least one sub-band associated with the BWP in which grants are to be transmitted. The set of instructions, when executed by one or more processors of the network node, may cause the network node to transmit, in the at least one sub-band, DCI including a grant that schedules a communication in one or more sub-bands associated with the BWP.

Some aspects described herein relate to an apparatus for wireless communication. The apparatus may include means for receiving a BWP configuration indicating that a BWP is configured with cross sub-band scheduling, the BWP configuration indicating at least one sub-band associated with the BWP in which grants are to be received. The apparatus may include means for receiving, in the at least one sub-band, DCI including a grant that schedules a communication in one or more sub-bands associated with the BWP.

Some aspects described herein relate to an apparatus for wireless communication. The apparatus may include means for transmitting a BWP configuration indicating that a BWP is configured with cross sub-band scheduling, the BWP configuration indicating at least one sub-band associated with the BWP in which grants are to be transmitted. The apparatus may include means for transmitting, in the at least one sub-band, DCI including a grant that schedules a communication in one or more sub-bands associated with the BWP.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example disaggregated base station architecture in accordance with the present disclosure.

FIG. 4 is a diagram illustrating examples of full-duplex communication in a wireless network in accordance with the present disclosure.

FIGS. 5A-5C are diagrams illustrating examples associated with cross sub-band scheduling in a full-duplex network in accordance with various aspects of the present disclosure.

FIG. 6 is a flowchart illustrating an example process performed, for example, by a UE that supports cross sub-band scheduling in a full-duplex network in accordance with the present disclosure.

FIG. 7 is a flowchart illustrating an example process performed, for example, by a network node that supports cross sub-band scheduling in a full-duplex network in accordance with the present disclosure.

FIG. 8 is a diagram of an example apparatus for wireless communication that supports cross sub-band scheduling in a full-duplex network in accordance with the present disclosure.

FIG. 9 is a diagram of an example apparatus for wireless communication that supports cross sub-band scheduling in a full-duplex network in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to cross sub-band scheduling in a full-duplex network. As used herein, cross sub-band scheduling refers to scheduling a UE for communications in one or more sub-bands associated with a bandwidth part (BWP) (for example, scheduling the UE in a first sub-band associated with the BWP, a second sub-band associated with the BWP, or in both the first sub-band and the second sub-band), where the communications can be scheduled based on scheduling information (for example, downlink control information (DCI)) received on any of the one or more sub-bands. Some aspects more specifically relate to a BWP configuration for a BWP that supports cross sub-band scheduling in a full-duplex network, and dynamic adaptation of the BWP configuration. In some aspects, a network node may transmit, and a UE may receive, a BWP configuration indicating that a BWP is configured with cross sub-band scheduling, with the BWP configuration indicating at least one sub-band associated with the BWP in which grants are to be communicated. In some aspects, the network node may transmit, and the UE may receive, DCI including a grant that schedules a communication in one or more sub-bands associated with the BWP, with the DCI being transmitted and received in the at least one sub-band indicated by the BWP configuration.

Particular aspects of the subject matter described in this disclosure can be implemented to realize one or more of the following potential advantages. In some examples, the described techniques can be used to reduce power consumption of the UE by eliminating a need for the UE to process the entire bandwidth of the BWP, while enabling the UE to be scheduled for communications in one or more sub-bands of the entire bandwidth. Further, in some examples, the described techniques can reduce buffering at the UE, thereby reducing power consumption and conserving memory and processing resources. Further, in some examples, the described techniques can improve decoding reliability of a physical downlink control channel (PDCCH) carrying DCI by enabling a frequency domain resource allocation (FDRA) field of the DCI to carry redundant bits. For example, if a UE is to be scheduled in only a single sub-band associated with the BWP, some bits of the FDRA field would indicate an FDRA associated with the single sub-band. However, other bits of the FDRA (that is, bits that would otherwise be used to indicate an FDRA associated with one or more other sub-bands associated with the BWP) may instead carry redundant bits associated with the single sub-band, thereby improving decoding reliability.

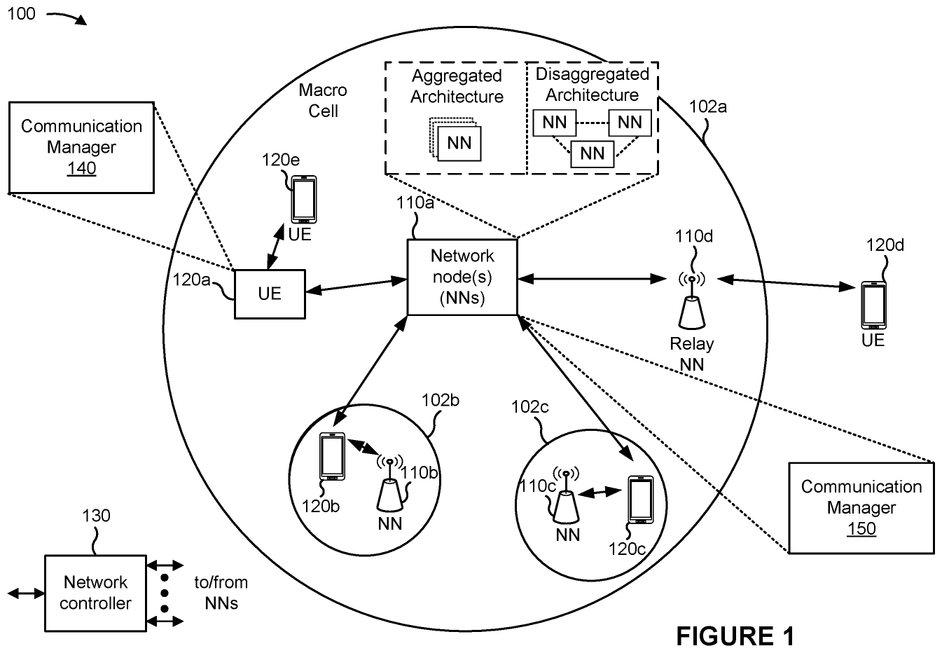

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive a bandwidth part (BWP) configuration indicating that a BWP is configured with cross sub-band scheduling, the BWP configuration indicating at least one sub-band associated with the BWP in which grants are to be received; and receive, in the at least one sub-band, downlink control information (DCI) including a grant that schedules a communication in one or more sub-bands associated with the BWP. Additionally or alternatively, the communication manager 140 may perform one or more other operations described herein.

In some aspects, the network node 110 may include a communication manager 150. As described in more detail elsewhere herein, the communication manager 150 may transmit a BWP configuration indicating that a BWP is configured with cross sub-band scheduling, the BWP configuration indicating at least one sub-band associated with the BWP in which grants are to be transmitted; and transmit, in the at least one sub-band, DCI including a grant that schedules a communication in one or more sub-bands associated with the BWP. Additionally or alternatively, the communication manager 150 may perform one or more other operations described herein.

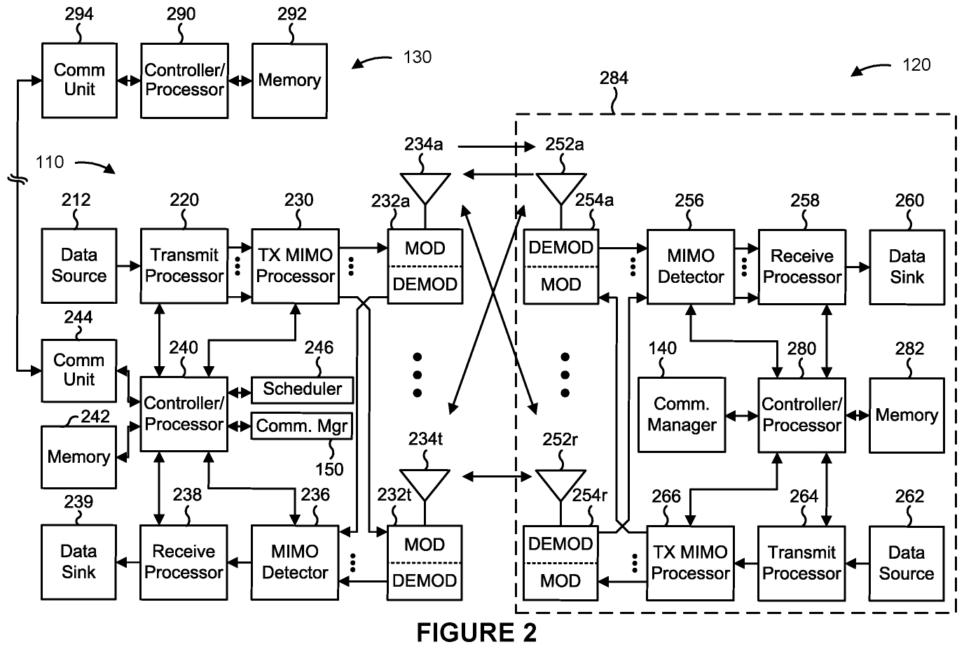

FIG. 2 is a diagram illustrating an example network node in communication with a UE in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

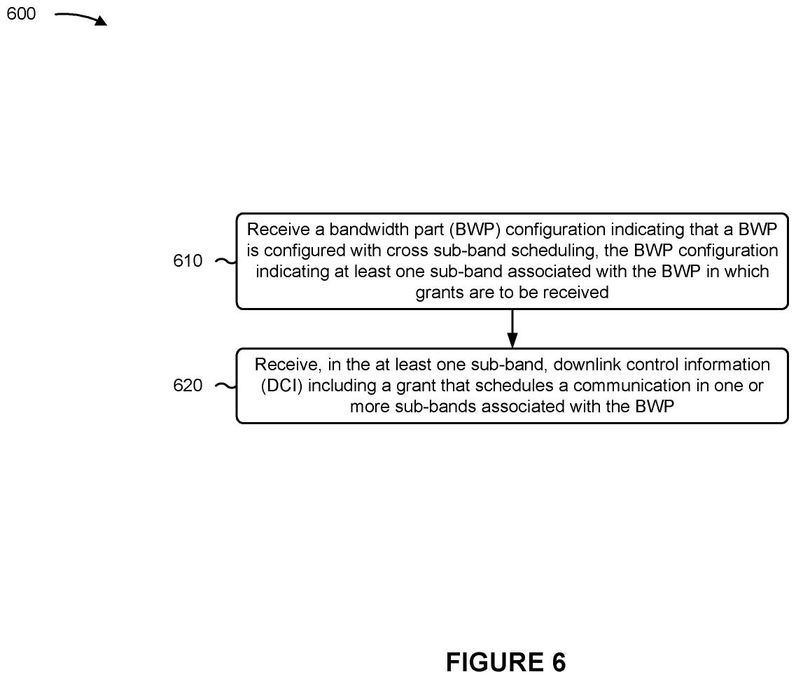

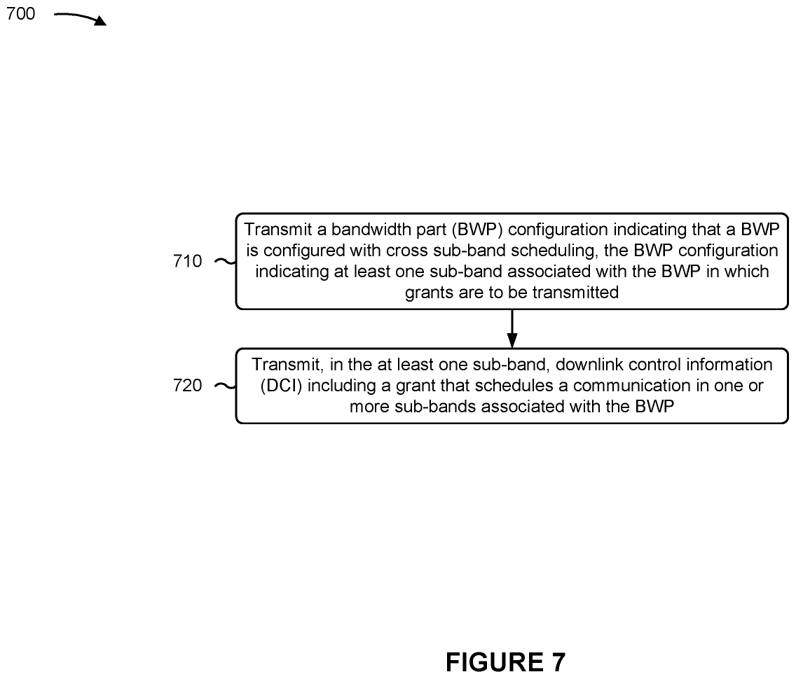

The controller/processor 240 of the network node 110, the controller/processor 280 of the UE 120, or any other component(s) of FIG. 2 may perform one or more techniques associated with cross sub-band scheduling in a full-duplex network, as described in more detail elsewhere herein. For example, the controller/processor 240 of the network node 110, the controller/processor 280 of the UE 120, or any other component(s) of FIG. 2 may perform or direct operations of, for example, process 600 of FIG. 6, process 700 of FIG. 7, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 600 of FIG. 6, process 700 of FIG. 7, or other processes as described herein. In some examples, executing instructions may include running the instructions, converting the instructions, compiling the instructions, or interpreting the instructions, among other examples.

In some aspects, the UE 120 includes means for receiving a BWP configuration indicating that a BWP is configured with cross sub-band scheduling, the BWP configuration indicating at least one sub-band associated with the BWP in which grants are to be received; or means for receiving, in the at least one sub-band, DCI including a grant that schedules a communication in one or more sub-bands associated with the BWP. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting a BWP configuration indicating that a BWP is configured with cross sub-band scheduling, the BWP configuration indicating at least one sub-band associated with the BWP in which grants are to be transmitted; or means for transmitting, in the at least one sub-band, DCI including a grant that schedules a communication in one or more sub-bands associated with the BWP. In some aspects, the means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

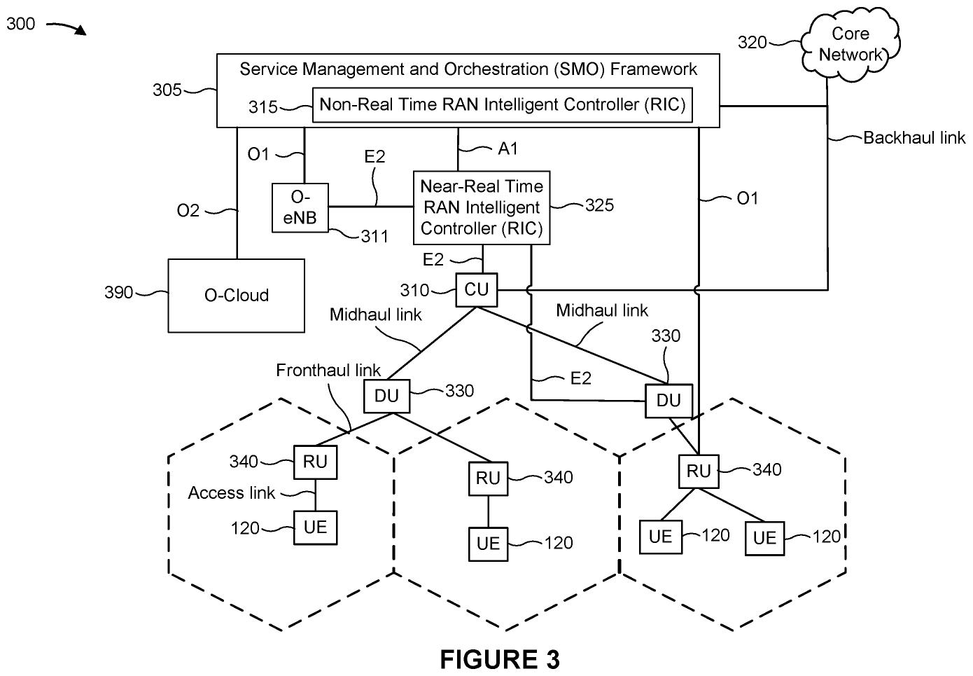

FIG. 3 is a diagram illustrating an example disaggregated base station architecture 300 in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an IFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

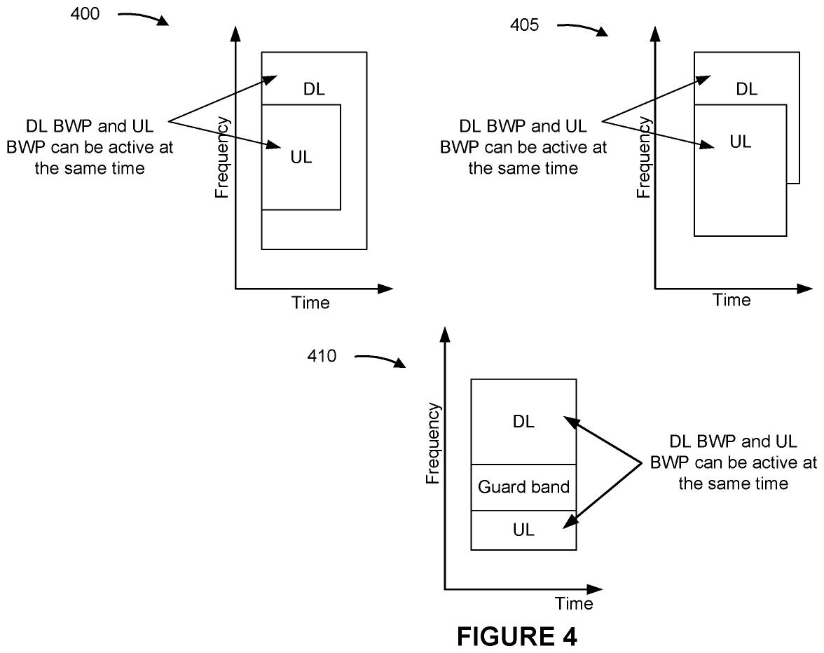

FIG. 4 is a diagram illustrating examples 400, 405, and 410 of full-duplex communication in a wireless network, in accordance with the present disclosure. “Full-duplex communication” in a wireless network refers to simultaneous bi-directional communication between devices in the wireless network. For example, a UE operating in a full-duplex mode may transmit an uplink communication and receive a downlink communication at the same time (for example, in the same slot or the same symbol). “Half-duplex communication” in a wireless network refers to unidirectional communications (for example, only downlink communication or only uplink communication) between devices at a given time (for example, in a given slot or a given symbol).

As shown in FIG. 4, examples 400 and 405 show examples of in-band full-duplex (IBFD) communication. In IBFD, a UE may transmit an uplink communication to a base station and receive a downlink communication from the base station on the same time and frequency resources. As shown in example 400, in a first example of IBFD, the time and frequency resources for uplink communication may fully overlap with the time and frequency resources for downlink communication. As shown in example 405, in a second example of IBFD, the time and frequency resources for uplink communication may partially overlap with the time and frequency resources for downlink communication.

As further shown in FIG. 4, example 410 shows an example of sub-band full-duplex (SBFD) communication, which may also be referred to as “sub-band frequency division duplex (SBFDD)” or “flexible duplex.” In SBFD, a UE may transmit an uplink communication to a base station and receive a downlink communication from the base station at the same time, but on different frequency resources. For example, the different frequency resources may be sub-bands of a frequency band, such as a time division duplexing band. In this case, the frequency resources used for downlink communication may be separated from the frequency resources used for uplink communication, in the frequency domain, by a guard band.

In some aspects, the techniques and apparatuses associated with cross sub-band scheduling in a full-duplex network described herein may be applied to full-duplex communications as described in association with FIG. 4.

A wireless communication system may support cross slot scheduling to reduce unnecessary buffering at a UE. For example, a UE may begin buffering an entire bandwidth of a downlink BWP for potential communication scheduling by a network node at the start of control channel monitoring (for example, physical downlink control channel (PDCCH) monitoring) in a search space occasion). This is because a communication can be scheduled by downlink control information (DCI) provided via the control channel as early as the start of the monitoring. However, there is a high probability that there is no communication scheduled for the UE in the search space occasion when, for example, the UE is not fully active. As a result, the UE may perform unnecessary buffering. To reduce such buffering, cross-slot scheduling can be adopted to ensure a minimum offset between a control channel and a communication scheduled by the control channel. This means that the UE need not buffer data during a period of time corresponding to the minimum offset. Further, the UE may not be required to buffer data after the minimum offset if the UE has not received any scheduling DCI in the search space occasion.

Cross slot scheduling can be applied for downlink communications and for uplink communications. In the case of downlink communications, K0 is a value that indicates a minimum offset between a downlink slot in which a PDCCH communication (carrying scheduling DCI) scheduling a physical downlink shared channel (PDSCH) communication is received and a slot in which the PDSCH communication is scheduled. In general, the UE does not expect to be scheduled a PDSCH communication having a K0 that is smaller than an active K0. In the case of uplink communications, K2 is a value that indicates a minimum offset between a downlink slot in which a PDCCH communication (carrying scheduling DCI) scheduling a physical uplink shared channel (PUSCH) communication is received and a slot in which the PUSCH communication is scheduled. In general, the UE does not expect to be scheduled a PUSCH communication having a K2 that is smaller than an active K2 value.

In operation, the offset values K0 and K2 can be configured via RRC signaling and can be configured per BWP, and there may be up to two candidate minimum offset values for both K0 and K2 (for a given BWP). A configuration of a single offset value (for either K0 and K2) is functionally identical to configuring a “zero” value along with a different configured value in a configuration of two offset values. The value “zero” is a valid configuration if two RRC values are configured for the BWP. The range of configured values is a range of integer values from 0 to 16 slots, and the slot is based on a numerology of the BWP. An active K0 for a downlink BWP or an active K2 for an uplink BWP can be signaled via, for example, a one-bit indication carried in DCI.

Cross-slot scheduling has implications on power saving at the UE. For example, if the UE is configured with a minimum K0 of two slots for a downlink BWP, then the UE may relax PDCCH decoding constraints in the downlink BWP and, in some cases, may be able to enter a sleep mode during two slots between the slot in which DCI scheduling a PDSCH communication is received and the slot in which the PDSCH communication is to be received, thereby reducing power consumption. Notably, cross slot scheduling reduces power consumption by controlling operation of the UE with respect to the time domain.

In the case of full-duplex communication, it is possible that a BWP may cover more than one sub-band in some combination of one or more downlink sub-bands and one or more uplink sub-bands. For example, to reduce or eliminate delay, it is undesirable to switch or modify a configuration of a BWP during the course of full-duplex communication when transitioning from a half-duplex slot to a full-duplex slot. Therefore, the BWP may in some scenarios span more than one sub-band.

In operation during full-duplex communication, a network node may decide to schedule a UE in one sub-band or more than one sub-band, depending on traffic load or interference, among other factors. For example, DCI communicated in a first sub-band of a BWP may schedule a first communication in the first sub-band and a second communication in a second (different) sub-band of the BWP. In some scenarios the network node may decide to schedule the UE in only one sub-band. A number of advantages can be realized if the UE has knowledge that the UE will be scheduled in only one sub-band of the BWP. One advantage is that the UE would not need to process the entire bandwidth of the BWP, thereby reducing power consumption of the UE. Notably, such energy savings could be realized if the BWP was switched or modified but, as noted above, this would lead to undesirable delay. Another advantage is that the UE would not need to buffer other sub-bands associated with the BWP (for example, if a communication is scheduled in the same sub-band in which scheduling DCI is received). Another advantage is that, since a frequency domain resource allocation (FDRA) field in the scheduling DCI is defined per-BWP (rather than per-sub-band), the FDRA field could carry redundant bits, thereby improving decoding reliability of the PDCCH.

Various aspects relate generally to cross sub-band scheduling in a full-duplex network. As used herein, cross sub-band scheduling refers to scheduling a UE for communications in one or more sub-bands associated with a BWP (for example, scheduling the UE in a first sub-band associated with the BWP, a second sub-band associated with the BWP, or in both the first sub-band and the second sub-band). Some aspects more specifically relate to a BWP configuration for a BWP that supports cross sub-band scheduling in a full-duplex network, and dynamic adaptation of the BWP configuration. In some aspects, a network node may transmit, and a UE may receive, a BWP configuration indicating that a BWP is configured with cross sub-band scheduling, with the BWP configuration indicating at least one sub-band associated with the BWP in which grants are to be communicated. In some aspects, the network node may transmit, and the UE may receive, DCI including a grant that schedules a communication in one or more sub-bands associated with the BWP, with the DCI being transmitted and received in the at least one sub-band indicated by the BWP configuration.

Particular aspects of the subject matter described in this disclosure can be implemented to realize one or more of the following potential advantages. In some examples, the described techniques can be used to reduce power consumption of the UE by eliminating a need for the UE to process the entire bandwidth of the BWP, while enabling the UE to be scheduled for communications in one or more sub-bands of the entire bandwidth. Further, in some examples, the described techniques can reduce buffering at the UE, thereby reducing power consumption and conserving processing resources. Notably, the techniques for cross sub-band scheduling described herein reduce power consumption by controlling operation of the UE with respect to the frequency domain (rather than the time domain) Further, in some examples, the described techniques can improve decoding reliability of a PDCCH carrying DCI by enabling an FDRA field of DCI to carry redundant bits. For example, if a UE is to be scheduled in only a single sub-band associated with the BWP, some bits of the FDRA field would indicate an FDRA associated with the single sub-band. However, other bits of the FDRA (that is, bits that would otherwise be used to indicate an FDRA associated with one or more other sub-bands associated with the BWP) may instead carry redundant bits associated with the single sub-band, thereby improving decoding reliability.

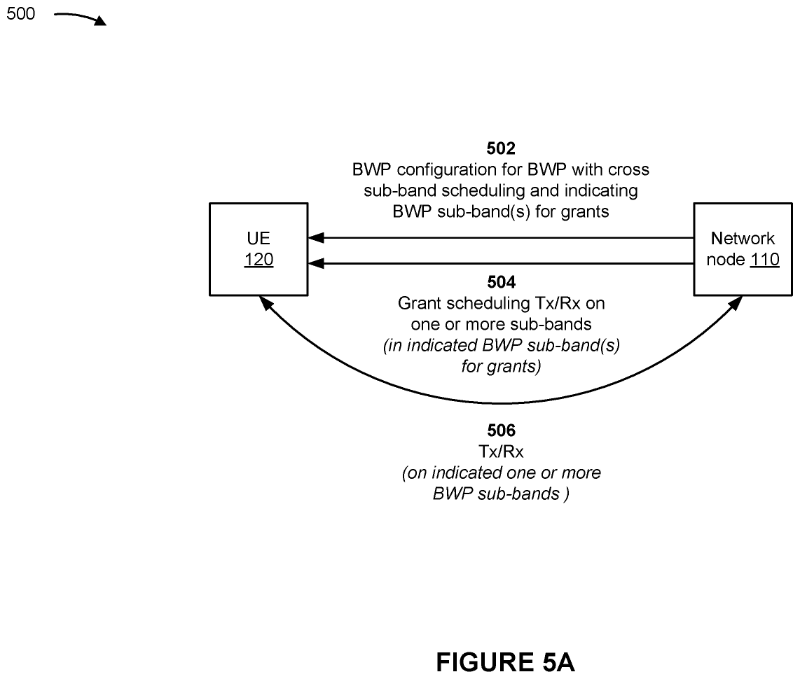

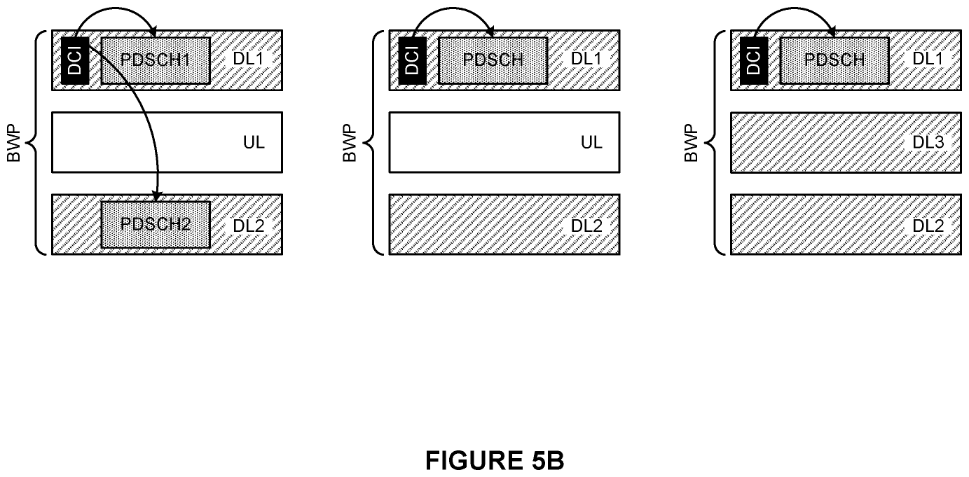

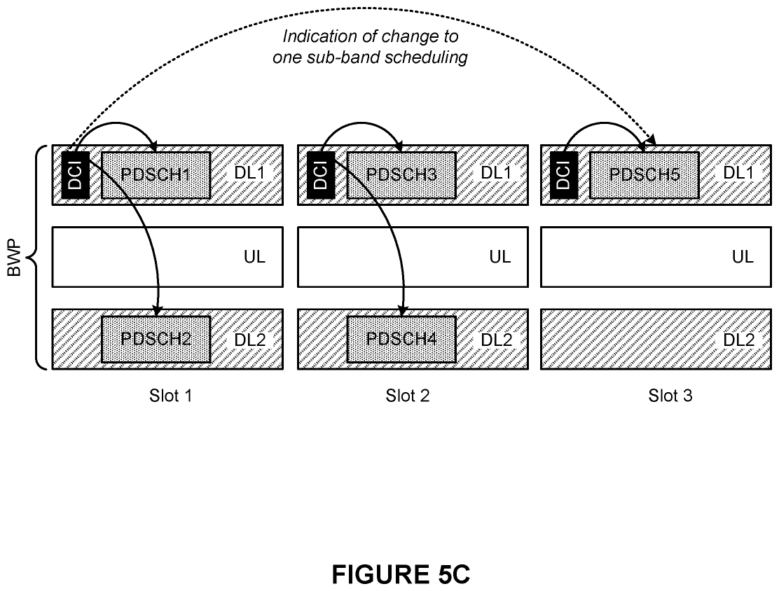

FIGS. 5A-5C are diagrams illustrating examples associated with cross sub-band scheduling in a full-duplex network in accordance with various aspects of the present disclosure.

As shown in FIG. 5A, an example 500 includes communication between a network node 110 and a UE 120. In some aspects, the network node 110 and the UE 120 may be included in a wireless network, such as a wireless network 100. The network node 110 and the UE 120 may communicate via a wireless access link, which may include an uplink and a downlink. In some aspects, the network node 110 and the UE 120 may support full-duplex communication.

In a first operation 502, the network node 110 may transmit, and the UE 120 may receive, a BWP configuration indicating that a BWP is configured with cross sub-band scheduling. That is, the BWP configuration may configure a BWP that supports cross sub-band scheduling (for example, when the BWP is active in a full-duplex slot or in a half-duplex slot that is divided into multiple sub-bands). In some aspects, the network node 110 may transmit, and the UE 120 may receive, the BWP configuration via RRC signaling That is, the BWP that supports cross sub-band scheduling may in some aspects be RRC-configured.

In some aspects, the BWP configuration indicates at least one sub-band associated with the BWP in which grants scheduling communications are to be communicated. For example, the BWP configuration may indicate that the UE 120 can expect grants to be communicated in a single sub-band of the BWP. As another example, the BWP configuration may indicate that the UE 120 can expect grants to be communicated in any one or more of a plurality of sub-bands of the BWP. In some aspects, the BWP configuration may include information that identifies the one or more sub-bands in which the UE 120 may expect grants to be communicated.

In some aspects, the BWP configuration includes an indication of a set of sub-bands associated with the BWP in which communications are to be transmitted (in the case of uplink communications) or received (in the case of downlink communications). For example, the BWP configuration may indicate that the UE 120 can expect communications on a single sub-band associated with the BWP. As another example, the BWP configuration may indicate that the UE 120 can expect communications on any one or more of a plurality of sub-bands associated with the BWP. In some aspects, the BWP configuration may include information that identifies the set of sub-bands on which the UE 120 may expect communications.

In some aspects, the BWP configuration may be valid only when the BWP overlaps in the frequency domain with more than one sub-band. That is, the BWP configuration may not apply when the BWP overlaps in the frequency domain with a single sub-band. Thus, in some aspects, the UE 120 may apply the BWP configuration based at least in part on a determination that the BWP overlaps multiple sub-bands in the frequency domain.

In a second operation 504, the network node 110 may transmit, and the UE 120 may receive, DCI including a grant that schedules one or more communications in one or more sub-bands associated with the BWP. In some aspects, the network node 110 may transmit, and the UE 120 may receive, the DCI including the grant in the at least one sub-band associated with the BWP in which grants are to be received by the UE 120. In some aspects, the DCI may schedule one or more downlink communications, such as one or more PDSCH communications. In some aspects, the DCI may schedule one or more uplink communications, such as one or more PUSCH communications. In some aspects, the grant in the DCI may schedule the one or more communications for transmission or reception in a full-duplex slot. Alternatively, in some aspects, the grant in the DCI may schedule the communication for transmission or reception in a half-duplex slot. Therefore, in some aspects, the BWP configuration can be applied in a half-duplex slot (for example, when the half-duplex slot is divided into multiple sub-bands).

In some aspects, the DCI may include an indication of an update to the set of sub-bands associated with the BWP in which communications are to be transmitted or received. For example, the BWP configuration may indicate the set of sub-bands on which the UE 120 can expect communications, as described above. Here, the DCI scheduling the communication can include an indication (for example, a one-bit indication) that indicates to the UE 120 whether future communications will occur in the same set of sub-bands as indicated in the BWP configuration or a different set of sub-bands of the BWP, as indicated in the DCI. In this way, the set of sub-bands on which the UE 120 may expect communications can be dynamically updated via DCI.

In some aspects, the update to the set of sub-bands is applicable a particular quantity of slots after receiving the DCI. That is, in some aspects, the update to the set of sub-bands may be activated a particular quantity of slots after the slot in which the UE 120 receives the DCI. In some aspects, the particular quantity of slots may be configured via RRC signaling. In some aspects, the particular quantity of slots may be configured on a per-BWP basis. In some aspects, the particular quantity of slots may be configured on a per-component-carrier basis. In some aspects, the particular quantity of slots may be based at least in part on a capability of the UE 120. In some aspects, the UE 120 may indicate, to the network node 110, capability information that indicates a minimum quantity of slots needed by the UE 120 to apply an update to the set of sub-bands.

In some aspects, an FDRA indicated in the DCI may span more than one sub-band associated with the BWP. In such an aspect, if the BWP configuration (or the DCI) indicates that communications are to occur in a single sub-band associated with the BWP, then the UE 120 may identify an error. That is, the UE 120 may identify an error case when the FDRA in the DCI spans multiple sub-bands and the UE 120 is expecting communications on a single sub-band. Additionally or alternatively, the UE 120 may identify an actual FDRA (in other words, an FDRA to be used by the UE 120 in association with transmitting or receiving the communication) based at least in part on an overlap between the FDRA indicated in the DCI and the single sub-band in which communications are to occur. That is, the UE 120 may assume that the actual FDRA is an overlap between the FDRA signaled by the DCI and the single sub-band in which the UE is expecting communications to occur.

In a third operation 506, the communication may be transmitted or received in the one or more sub-bands according to the grant. For example, in the case of a downlink communication (for example, a PDSCH communication), the network node 110 may transmit, and the UE 120 may receive, the downlink communication in the one or more sub-bands according to the grant. As another example, in the case of an uplink communication (for example, a PUSCH communication), the UE 120 may transmit, and the network node 110 may receive, the uplink communication in the one or more sub-bands according to the grant.

FIG. 5B is a diagram illustrating various examples of cross sub-band scheduling as described herein.

In the left example in FIG. 5B, a BWP includes a first downlink sub-band (DL1), an uplink sub-band (UL), and a second downlink sub-band (DL2). In this example, the BWP configuration indicates that the BWP is configured for cross sub-band scheduling, that the UE 120 can expect grants on the first downlink sub-band, and that the UE 120 can expect PDSCH communications to be scheduled on the first downlink sub-band and the second downlink sub-band. As shown, the network node 110 may transmit, and the UE 120 may receive, DCI on the first downlink sub-band. Here, the DCI schedules a first PDSCH communication (PDSCH1) on the first downlink sub-band and schedules a second PDSCH communication (PDSCH2) on the second downlink sub-band. The network node 110 may transmit, and the UE 120 may receive, the first PDSCH communication and the second PDSCH communication according to the grant.

In the center example in FIG. 5B, a BWP includes a first downlink sub-band (DL1), an uplink sub-band (UL), and a second downlink sub-band (DL2). In this example, the BWP configuration indicates that the BWP is configured for cross sub-band scheduling, that the UE 120 can expect grants on the first downlink sub-band, and that the UE 120 can expect PDSCH communications to be scheduled on the first downlink sub-only. As shown, the network node 110 may transmit, and the UE 120 may receive, DCI on the first downlink sub-band. Here, the DCI schedules a PDSCH communication (PDSCH) on the first downlink sub-band. The network node 110 may transmit, and the UE 120 may receive, the PDSCH communication according to the grant. Notably, in this example, the UE 120 is informed that the UE 120 will be scheduled in only one sub-band of the BWP. Therefore, the UE 120 does not need to process the entire bandwidth of the BWP, which reduces power consumption. Further, the UE 120 does not need to buffer other sub-bands associated with the BWP, which reduces power consumption and conserves memory and processing resources. Additionally, an FDRA field in the DCI could carry redundant bits in order to improved decoding reliability of the PDCCH.

In the right example in FIG. 5B, a BWP includes a first downlink sub-band (DL1), a second downlink sub-band (DL2), and a third downlink sub-band (DL3). In this example, the BWP configuration indicates that the BWP is configured for cross sub-band scheduling, that the UE 120 can expect grants on the first downlink sub-band, and that the UE 120 can expect PDSCH communications to be scheduled on the first downlink sub-only. As shown, the network node 110 may transmit, and the UE 120 may receive, DCI on the first downlink sub-band. Here, the DCI schedules a PDSCH communication (PDSCH) on the first downlink sub-band. The network node 110 may transmit, and the UE 120 may receive, the PDSCH communication according to the grant. Notably, in this example, the BWP configuration is applied to a half-duplex slot. Further, the same advantages as described with respect to the center image of FIG. 5B are realized.

FIG. 5C is a diagram illustrating an example of a dynamic update associated with cross sub-band scheduling as described herein.

In the example in FIG. 5C, a BWP includes a first downlink sub-band (DL1), an uplink sub-band (UL), and a second downlink sub-band (DL2). In this example, the BWP configuration indicates that the BWP is configured for cross sub-band scheduling, that the UE 120 can expect grants on the first downlink sub-band, and that the UE 120 can expect PDSCH communications to be scheduled on the first downlink sub-band and the second downlink sub-band. As shown, the network node 110 may transmit, and the UE 120 may receive, DCI on the first downlink sub-band in a first slot (slot 1). Here, the DCI in the first slot schedules a first PDSCH communication (PDSCH1) on the first downlink sub-band and schedules a second PDSCH communication (PDSCH2) on the second downlink sub-band. In this example, the DCI includes an indication that the set of sub-bands on which the UE 120 can expect downlink communications has been updated to include only the first downlink sub-band (rather than the first downlink sub-band and the second downlink sub-band). Here, the update to the set of sub-bands is applicable two slots after receiving the DCI (for example, based at least in part on an RRC configuration or a capability of the UE 120, among other examples). As shown, the network node 110 may transmit, and the UE 120 may receive, the first PDSCH communication and the second PDSCH communication in the first slot according to the grant.

As further shown, the network node 110 may transmit, and the UE 120 may receive, additional DCI on the first downlink sub-band in a second slot (slot 2). Here, the DCI in the second slot schedules a third PDSCH communication (PDSCH3) on the first downlink sub-band and schedules a fourth PDSCH communication (PDSCH4) on the second downlink sub-band. Notably, the update to the set of sub-bands has not been applied to the second slot. As shown, the network node 110 may transmit, and the UE 120 may receive, the third PDSCH communication and the fourth PDSCH communication in the second slot according to the grant.

As further shown, the network node 110 may transmit, and the UE 120 may receive, additional DCI on the first downlink sub-band in a third slot (slot 3). Here, the DCI in the third slot schedules a fifth PDSCH communication (PDSCH5) on the first downlink sub-band. Notably, the update to the set of sub-bands is applied to the third slot. As shown, the network node 110 may transmit, and the UE 120 may receive, the fifth PDSCH communication in the third slot according to the grant. In this example, the UE 120 is informed that the UE 120 will be scheduled in only one sub-band of the BWP in the third slot. Therefore, the UE 120 does not need to process the entire bandwidth of the BWP during the third slot, which reduces power consumption. Further, the UE 120 does not need to buffer other sub-bands associated with the BWP during the third slot, which reduces power consumption and conserves memory and processing resources. Additionally, an FDRA field in the DCI of the third slot could carry redundant bits in order to improved decoding reliability of the PDCCH.

FIG. 6 is a flowchart illustrating an example process 600 performed, for example, by a UE that supports cross sub-band scheduling in a full-duplex network in accordance with the present disclosure. Example process 600 is an example where the UE (for example, UE 120) performs operations associated with cross sub-band scheduling in a full-duplex network.

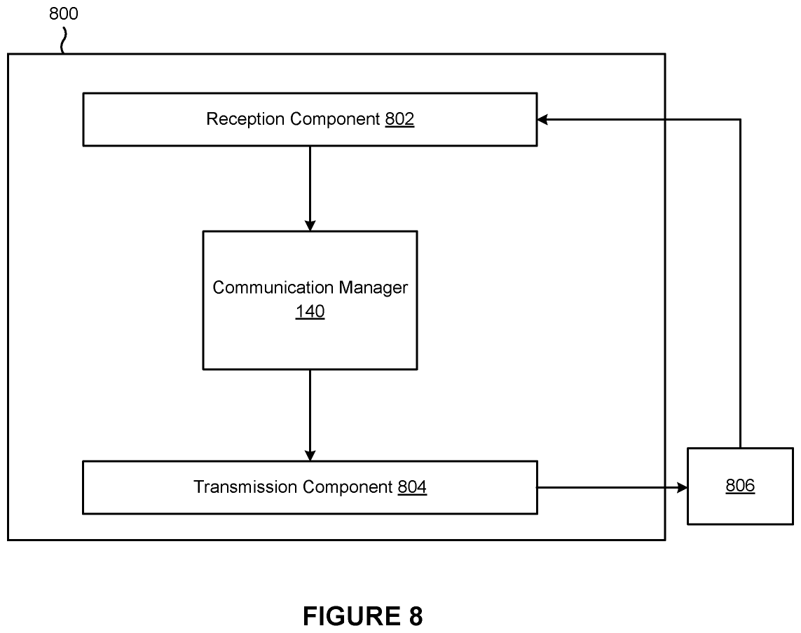

As shown in FIG. 6, in some aspects, process 600 may include receiving a BWP configuration indicating that a BWP is configured with cross sub-band scheduling, the BWP configuration indicating at least one sub-band associated with the BWP in which grants are to be received (block 610). For example, the UE (such as by using communication manager 140 or reception component 802, depicted in FIG. 8) may receive a BWP configuration indicating that a BWP is configured with cross sub-band scheduling, the BWP configuration indicating at least one sub-band associated with the BWP in which grants are to be received, as described above.

As further shown in FIG. 6, in some aspects, process 600 may include receiving, in the at least one sub-band, DCI including a grant that schedules a communication in one or more sub-bands associated with the BWP (block 620). For example, the UE (such as by using communication manager 140 or reception component 802, depicted in FIG. 8) may receive, in the at least one sub-band, DCI including a grant that schedules a communication in one or more sub-bands associated with the BWP, as described above.

Process 600 may include additional aspects, such as any single aspect or any combination of aspects described below or in connection with one or more other processes described elsewhere herein.

In a first additional aspect, process 600 includes transmitting or receiving the communication in the one or more sub-bands according to the grant.

In a second additional aspect, alone or in combination with the first aspect, the BWP configuration includes an indication of a set of sub-bands associated with the BWP in which communications are to be transmitted or received, the one or more sub-bands being included in the set of sub-bands.

In a third additional aspect, alone or in combination with one or more of the first and second aspects, process 600 includes applying the BWP configuration based at least in part on a determination that the BWP overlaps multiple sub-bands in a frequency domain.

In a fourth additional aspect, alone or in combination with one or more of the first through third aspects, the grant in the DCI schedules the communication for transmission or reception in a full-duplex slot.

In a fifth additional aspect, alone or in combination with one or more of the first through fourth aspects, the grant in the DCI schedules the communication for transmission or reception in a half-duplex slot.

In a sixth additional aspect, alone or in combination with one or more of the first through fifth aspects, the DCI includes an indication of an update to a set of sub-bands associated with the BWP in which communications are to be transmitted or received, the update to the set of sub-bands being applicable a particular quantity of slots after receiving the DCI.

In a seventh additional aspect, alone or in combination with one or more of the first through sixth aspects, the particular quantity of slots is configured on a per-BWP basis.

In an eighth additional aspect, alone or in combination with one or more of the first through seventh aspects, the particular quantity of slots is configured on a per-component-carrier basis.

In a ninth additional aspect, alone or in combination with one or more of the first through eighth aspects, the particular quantity of slots is based at least in part on a capability of the UE.

In a tenth additional aspect, alone or in combination with one or more of the first through ninth aspects, an FDRA indicated in the DCI spans more than one sub-band associated with the BWP, and process 600 includes identifying an error based at least in part on an indication that communications are to be transmitted or received in a single sub-band.

In an eleventh additional aspect, alone or in combination with one or more of the first through tenth aspects, an FDRA indicated in the DCI spans more than one sub-band associated with the BWP, and process 600 includes identifying an actual FDRA based at least in part on an overlap between the FDRA and a single sub-band based at least in part on an indication that communications are to be transmitted or received in the single sub-band.

FIG. 7 is a flowchart illustrating an example process 700 performed, for example, by a network node that supports cross sub-band scheduling in a full-duplex network in accordance with the present disclosure. Example process 700 is an example where the network node (for example, network node 110) performs operations associated with cross sub-band scheduling in a full-duplex network.

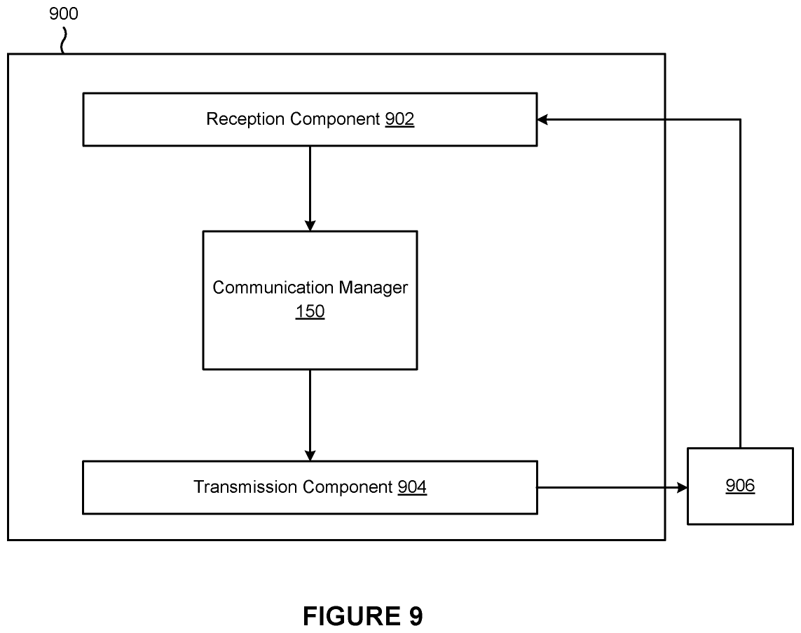

As shown in FIG. 7, in some aspects, process 700 may include transmitting a BWP configuration indicating that a BWP is configured with cross sub-band scheduling, the BWP configuration indicating at least one sub-band associated with the BWP in which grants are to be transmitted (block 710). For example, the network node (such as by using communication manager 150 or transmission component 904, depicted in FIG. 9) may transmit a BWP configuration indicating that a BWP is configured with cross sub-band scheduling, the BWP configuration indicating at least one sub-band associated with the BWP in which grants are to be transmitted, as described above.

As further shown in FIG. 7, in some aspects, process 700 may include transmitting, in the at least one sub-band, DCI including a grant that schedules a communication in one or more sub-bands associated with the BWP (block 720). For example, the network node (such as by using communication manager 150 or transmission component 904, depicted in FIG. 9) may transmit, in the at least one sub-band, DCI including a grant that schedules a communication in one or more sub-bands associated with the BWP, as described above.

Process 700 may include additional aspects, such as any single aspect or any combination of aspects described below or in connection with one or more other processes described elsewhere herein.

In a first additional aspect, process 700 includes transmitting or receiving the communication in the one or more sub-bands according to the grant.

In a second additional aspect, alone or in combination with the first aspect, the BWP configuration includes an indication of a set of sub-bands associated with the BWP in which communications are to be transmitted or received, the one or more sub-bands being included in the set of sub-bands.

In a third additional aspect, alone or in combination with one or more of the first and second aspects, the grant in the DCI schedules the communication for transmission or reception in a full-duplex slot.

In a fourth additional aspect, alone or in combination with one or more of the first through third aspects, the grant in the DCI schedules the communication for transmission or reception in a half-duplex slot.

In a fifth additional aspect, alone or in combination with one or more of the first through fourth aspects, the DCI includes an indication of an update to a set of sub-bands associated with the BWP in which communications are to be transmitted or received, the update to the set of sub-bands being applicable a particular quantity of slots after receiving the DCI.

In a sixth additional aspect, alone or in combination with one or more of the first through fifth aspects, the particular quantity of slots is configured on a per-BWP basis.

In a seventh additional aspect, alone or in combination with one or more of the first through sixth aspects, the particular quantity of slots is configured on a per-component-carrier basis.

In an eighth additional aspect, alone or in combination with one or more of the first through seventh aspects, the particular quantity of slots is based at least in part on a capability of a UE.

FIG. 8 is a diagram of an example apparatus 800 for wireless communication that supports cross sub-band scheduling in a full-duplex network in accordance with the present disclosure. The apparatus 800 may be a UE, or a UE may include the apparatus 800. In some aspects, the apparatus 800 includes a reception component 802, a transmission component 804, and a communication manager 140, which may be in communication with one another (for example, via one or more buses). As shown, the apparatus 800 may communicate with another apparatus 806 (such as a UE, a network node, or another wireless communication device) using the reception component 802 and the transmission component 804.

In some aspects, the apparatus 800 may be configured to perform one or more operations described herein in connection with FIGS. 5A-5C. Additionally or alternatively, the apparatus 800 may be configured to perform one or more processes described herein, such as process 600 of FIG. 6. In some aspects, the apparatus 800 may include one or more components of the UE described above in connection with FIG. 2.

The reception component 802 may receive communications, such as reference signals, control information, data communications, or a combination thereof, from the apparatus 806. The reception component 802 may provide received communications to one or more other components of the apparatus 800, such as the communication manager 140. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 802 may include one or more antennas, a modem, a demodulator, a MIMO detector, a receive processor, a controller/processor, a memory, or a combination thereof, of the UE described above in connection with FIG. 2.

The transmission component 804 may transmit communications, such as reference signals, control information, data communications, or a combination thereof, to the apparatus 806. In some aspects, the communication manager 140 may generate communications and may transmit the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described above in connection with FIG. 2. In some aspects, the transmission component 804 may be co-located with the reception component 802 in a transceiver.

The communication manager 140 may receive or may cause the reception component 802 to receive a BWP configuration indicating that a BWP is configured with cross sub-band scheduling, the BWP configuration indicating at least one sub-band associated with the BWP in which grants are to be received. The communication manager 140 may receive or may cause the reception component 802 to receive, in the at least one sub-band, DCI including a grant that schedules a communication in one or more sub-bands associated with the BWP. In some aspects, the communication manager 140 may perform one or more operations described elsewhere herein as being performed by one or more components of the communication manager 140.

The communication manager 140 may include a controller/processor, a memory, or a combination thereof, of the UE described above in connection with FIG. 2. In some aspects, the communication manager 140 includes a set of components. Alternatively, the set of components may be separate and distinct from the communication manager 140. In some aspects, one or more components of the set of components may include or may be implemented within a controller/processor, a memory, or a combination thereof, of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive a BWP configuration indicating that a BWP is configured with cross sub-band scheduling, the BWP configuration indicating at least one sub-band associated with the BWP in which grants are to be received. The reception component 802 may receive, in the at least one sub-band, DCI including a grant that schedules a communication in one or more sub-bands associated with the BWP.

The transmission component 804 or the reception component 802 may transmit or receive, respectively, the communication in the one or more sub-bands according to the grant.

The transmission component 804 or the reception component 802 may apply the BWP configuration based at least in part on a determination that the BWP overlaps multiple sub-bands in a frequency domain.

FIG. 9 is a diagram of an example apparatus 900 for wireless communication that supports cross sub-band scheduling in a full-duplex network in accordance with the present disclosure. The apparatus 900 may be a network node, or a network node may include the apparatus 900. In some aspects, the apparatus 900 includes a reception component 902, a transmission component 904, and a communication manager 150, which may be in communication with one another (for example, via one or more buses). As shown, the apparatus 900 may communicate with another apparatus 906 (such as a UE, a network node, or another wireless communication device) using the reception component 902 and the transmission component 904.

In some aspects, the apparatus 900 may be configured to perform one or more operations described herein in connection with FIGS. 5A-5C. Additionally or alternatively, the apparatus 900 may be configured to perform one or more processes described herein, such as process 700 of FIG. 7. In some aspects, the apparatus 900 may include one or more components of the network node described above in connection with FIG. 2.

The reception component 902 may receive communications, such as reference signals, control information, data communications, or a combination thereof, from the apparatus 906. The reception component 902 may provide received communications to one or more other components of the apparatus 900, such as the communication manager 150. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 902 may include one or more antennas, a modem, a demodulator, a MIMO detector, a receive processor, a controller/processor, a memory, or a combination thereof, of the network node described above in connection with FIG. 2.

The transmission component 904 may transmit communications, such as reference signals, control information, data communications, or a combination thereof, to the apparatus 906. In some aspects, the communication manager 150 may generate communications and may transmit the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the network node described above in connection with FIG. 2. In some aspects, the transmission component 904 may be co-located with the reception component 902 in a transceiver.

The communication manager 150 may transmit or may cause the transmission component 904 to transmit a BWP configuration indicating that a BWP is configured with cross sub-band scheduling, the BWP configuration indicating at least one sub-band associated with the BWP in which grants are to be transmitted. The communication manager 150 may transmit or may cause the transmission component 904 to transmit, in the at least one sub-band, DCI including a grant that schedules a communication in one or more sub-bands associated with the BWP. In some aspects, the communication manager 150 may perform one or more operations described elsewhere herein as being performed by one or more components of the communication manager 150.

The communication manager 150 may include a controller/processor, a memory, a scheduler, a communication unit, or a combination thereof, of the network node described above in connection with FIG. 2. In some aspects, the communication manager 150 includes a set of components. Alternatively, the set of components may be separate and distinct from the communication manager 150. In some aspects, one or more components of the set of components may include or may be implemented within a controller/processor, a memory, a scheduler, a communication unit, or a combination thereof, of the network node described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The transmission component 904 may transmit a BWP configuration indicating that a BWP is configured with cross sub-band scheduling, the BWP configuration indicating at least one sub-band associated with the BWP in which grants are to be transmitted. The transmission component 904 may transmit, in the at least one sub-band, DCI including a grant that schedules a communication in one or more sub-bands associated with the BWP.

The transmission component 904 or the reception component 902 may transmit or receive, respectively, the communication in the one or more sub-bands according to the grant.

The following provides an overview of some Aspects of the present disclosure:

Aspect 1: A method of wireless communication performed by a UE, comprising: receiving a BWP configuration indicating that a BWP is configured with cross sub-band scheduling, the BWP configuration indicating at least one sub-band associated with the BWP in which grants are to be received; and receiving, in the at least one sub-band, DCI including a grant that schedules a communication in one or more sub-bands associated with the BWP.

Aspect 2: The method of Aspect 1, further comprising transmitting or receiving the communication in the one or more sub-bands according to the grant.

Aspect 3: The method of any of Aspects 1-2, wherein the BWP configuration includes an indication of a set of sub-bands associated with the BWP in which communications are to be transmitted or received, the one or more sub-bands being included in the set of sub-bands.

Aspect 4: The method of any of Aspects 1-3, further comprising applying the BWP configuration based at least in part on a determination that the BWP overlaps multiple sub-bands in a frequency domain.

Aspect 5: The method of any of Aspects 1-4, wherein the grant in the DCI schedules the communication for transmission or reception in a full-duplex slot.

Aspect 6: The method of any of Aspects 1-4, wherein the grant in the DCI schedules the communication for transmission or reception in a half-duplex slot.

Aspect 7: The method of any of Aspects 1-6, wherein the DCI includes an indication of an update to a set of sub-bands associated with the BWP in which communications are to be transmitted or received, the update to the set of sub-bands being applicable a particular quantity of slots after receiving the DCI.

Aspect 8: The method of Aspect 7, wherein the particular quantity of slots is configured on a per-BWP basis.

Aspect 9: The method of Aspect 7, wherein the particular quantity of slots is configured on a per-component-carrier basis.

Aspect 10: The method of any of Aspects 7-9, wherein the particular quantity of slots is based at least in part on a capability of the UE.

Aspect 11: The method of any of Aspects 1-10, wherein an FDRA indicated in the DCI spans more than one sub-band associated with the BWP, and the method further comprises identifying an error based at least in part on an indication that communications are to be transmitted or received in a single sub-band.

Aspect 12: The method of any of Aspects 1-10, wherein an FDRA indicated in the DCI spans more than one sub-band associated with the BWP, and the method further comprises identifying an actual FDRA based at least in part on an overlap between the FDRA and a single sub-band based at least in part on an indication that communications are to be transmitted or received in the single sub-band.

Aspect 13: A method of wireless communication performed by a network node, comprising: transmitting a BWP configuration indicating that a BWP is configured with cross sub-band scheduling, the BWP configuration indicating at least one sub-band associated with the BWP in which grants are to be transmitted; and transmitting, in the at least one sub-band, DCI including a grant that schedules a communication in one or more sub-bands associated with the BWP.

Aspect 14: The method of Aspect 13, further comprising transmitting or receiving the communication in the one or more sub-bands according to the grant.

Aspect 15: The method of any of Aspects 13-14, wherein the BWP configuration includes an indication of a set of sub-bands associated with the BWP in which communications are to be transmitted or received, the one or more sub-bands being included in the set of sub-bands.

Aspect 16: The method of any of Aspects 13-15, wherein the grant in the DCI schedules the communication for transmission or reception in a full-duplex slot.

Aspect 17: The method of any of Aspects 13-15, wherein the grant in the DCI schedules the communication for transmission or reception in a half-duplex slot.

Aspect 18: The method of any of Aspects 13-17, wherein the DCI includes an indication of an update to a set of sub-bands associated with the BWP in which communications are to be transmitted or received, the update to the set of sub-bands being applicable a particular quantity of slots after receiving the DCI.

Aspect 19: The method of Aspect 18, wherein the particular quantity of slots is configured on a per-BWP basis.

Aspect 20: The method of Aspect 18, wherein the particular quantity of slots is configured on a per-component-carrier basis.

Aspect 21: The method of any of Aspects 18-20, wherein the particular quantity of slots is based at least in part on a capability of a user equipment.

Aspect 22: An apparatus for wireless communication at a device, comprising a processor; memory coupled with the processor; and instructions stored in the memory and executable by the processor to cause the apparatus to perform the method of one or more of Aspects 1-12.

Aspect 23: A device for wireless communication, comprising a memory and one or more processors coupled to the memory, the one or more processors configured to perform the method of one or more of Aspects 1-12.

Aspect 24: An apparatus for wireless communication, comprising at least one means for performing the method of one or more of Aspects 1-12.

Aspect 25: A non-transitory computer-readable medium storing code for wireless communication, the code comprising instructions executable by a processor to perform the method of one or more of Aspects 1-12.

Aspect 26: A non-transitory computer-readable medium storing a set of instructions for wireless communication, the set of instructions comprising one or more instructions that, when executed by one or more processors of a device, cause the device to perform the method of one or more of Aspects 1-12.

Aspect 27: An apparatus for wireless communication at a device, comprising a processor; memory coupled with the processor; and instructions stored in the memory and executable by the processor to cause the apparatus to perform the method of one or more of Aspects 13-21.

Aspect 28: A device for wireless communication, comprising a memory and one or more processors coupled to the memory, the one or more processors configured to perform the method of one or more of Aspects 13-21.

Aspect 29: An apparatus for wireless communication, comprising at least one means for performing the method of one or more of Aspects 13-21.

Aspect 30: A non-transitory computer-readable medium storing code for wireless communication, the code comprising instructions executable by a processor to perform the method of one or more of Aspects 13-21.

Aspect 31: A non-transitory computer-readable medium storing a set of instructions for wireless communication, the set of instructions comprising one or more instructions that, when executed by one or more processors of a device, cause the device to perform the method of one or more of Aspects 13-21.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A user equipment (UE) for wireless communication, comprising:
at least one memory; and
at least one processor communicatively coupled with the at least one memory, the at least one processor configured to cause the UE to:
receive a bandwidth part (BWP) configuration indicating that a BWP is configured with cross sub-band scheduling, the BWP configuration indicating at least one sub-band associated with the BWP in which grants are to be received; and
receive, in the at least one sub-band, downlink control information (DCI) including a grant that schedules a communication in one or more sub-bands associated with the BWP.

2. The UE of claim 1, wherein the at least one processor is further configured to cause the UE to transmit or receiving the communication in the one or more sub-bands according to the grant.

3. The UE of claim 1, wherein the BWP configuration includes an indication of a set of sub-bands associated with the BWP in which communications are to be transmitted or received, the one or more sub-bands being included in the set of sub-bands.

4. The UE of claim 1, wherein the at least one processor is further configured to cause the UE to apply the BWP configuration based at least in part on a determination that the BWP overlaps multiple sub-bands in a frequency domain.

5. The UE of claim 1, wherein the DCI includes an indication of an update to a set of sub-bands associated with the BWP in which communications are to be transmitted or received, the update to the set of sub-bands being applicable a particular quantity of slots after receiving the DCI.

6. The UE of claim 5, wherein the particular quantity of slots is configured on a per-BWP basis.

7. The UE of claim 5, wherein the particular quantity of slots is configured on a per-component-carrier basis.

8. The UE of claim 5, wherein the particular quantity of slots is based at least in part on a capability of the UE.

9. The UE of claim 1, wherein a frequency domain resource allocation (FDRA) indicated in the DCI spans more than one sub-band associated with the BWP, and the at least one processor is further configured to identify an error based at least in part on an indication that communications are to be transmitted or received in a single sub-band.

10. The UE of claim 1, wherein a frequency domain resource allocation (FDRA) indicated in the DCI spans more than one sub-band associated with the BWP, and the the at least one processor is further configured to identify an actual FDRA based at least in part on an overlap between the FDRA and a single sub-band based at least in part on an indication that communications are to be transmitted or received in the single sub-band.

11. A network node for wireless communication, comprising:
at least one memory; and
at least one processor communicatively coupled with the at least one memory, the at least one processor configured to cause the network node to:
transmit a bandwidth part (BWP) configuration indicating that a BWP is configured with cross sub-band scheduling, the BWP configuration indicating at least one sub-band associated with the BWP in which grants are to be transmitted; and
transmit, in the at least one sub-band, downlink control information (DCI) including a grant that schedules a communication in one or more sub-bands associated with the BWP.

12. The network node of claim 11, wherein the at least one processor is further configured to cause the network node to transmit or receiving the communication in the one or more sub-bands according to the grant.

13. The network node of claim 11, wherein the BWP configuration includes an indication of a set of sub-bands associated with the BWP in which communications are to be transmitted or received, the one or more sub-bands being included in the set of sub-bands.

14. The network node of claim 11, wherein the DCI includes an indication of an update to a set of sub-bands associated with the BWP in which communications are to be transmitted or received, the update to the set of sub-bands being applicable a particular quantity of slots after receiving the DCI.

15. The network node of claim 14, wherein the particular quantity of slots is configured on a per-BWP basis.

16. The network node of claim 14, wherein the particular quantity of slots is configured on a per-component-carrier basis.

17. The network node of claim 14, wherein the particular quantity of slots is based at least in part on a capability of a user equipment.

18. A method of wireless communication performed by a user equipment (UE), comprising:
receiving a bandwidth part (BWP) configuration indicating that a BWP is configured with cross sub-band scheduling, the BWP configuration indicating at least one sub-band associated with the BWP in which grants are to be received; and
receiving, in the at least one sub-band, downlink control information (DCI) including a grant that schedules a communication in one or more sub-bands associated with the BWP.

19. The method of claim 18, further comprising transmitting or receiving the communication in the one or more sub-bands according to the grant.

20. The method of claim 18, wherein the BWP configuration includes an indication of a set of sub-bands associated with the BWP in which communications are to be transmitted or received, the one or more sub-bands being included in the set of sub-bands.

21. The method of claim 18, further comprising applying the BWP configuration based at least in part on a determination that the BWP overlaps multiple sub-bands in a frequency domain.

22. The method of claim 18, wherein the DCI includes an indication of an update to a set of sub-bands associated with the BWP in which communications are to be transmitted or received, the update to the set of sub-bands being applicable a particular quantity of slots after receiving the DCI.

23. The method of claim 22, wherein the particular quantity of slots is configured on a per-BWP basis.

24. The method of claim 22, wherein the particular quantity of slots is configured on a per-component-carrier basis.

25. The method of claim 22, wherein the particular quantity of slots is based at least in part on a capability of the UE.

26. The method of claim 18, wherein a frequency domain resource allocation (FDRA) indicated in the DCI spans more than one sub-band associated with the BWP, and the method further comprises identifying an error based at least in part on an indication that communications are to be transmitted or received in a single sub-band.

27. The method of claim 18, wherein a frequency domain resource allocation (FDRA) indicated in the DCI spans more than one sub-band associated with the BWP, and the method further comprises identifying an actual FDRA based at least in part on an overlap between the FDRA and a single sub-band based at least in part on an indication that communications are to be transmitted or received in the single sub-band.

28. A method of wireless communication performed by a network node, comprising:
transmitting a bandwidth part (BWP) configuration indicating that a BWP is configured with cross sub-band scheduling, the BWP configuration indicating at least one sub-band associated with the BWP in which grants are to be transmitted; and
transmitting, in the at least one sub-band, downlink control information (DCI) including a grant that schedules a communication in one or more sub-bands associated with the BWP.

29. The method of claim 28, further comprising transmitting or receiving the communication in the one or more sub-bands according to the grant.

30. The method of claim 28, wherein the BWP configuration includes an indication of a set of sub-bands associated with the BWP in which communications are to be transmitted or received, the one or more sub-bands being included in the set of sub-bands.
